(19) United States
(12) Patent Application Publication
(10) Pub. No.: US 2018/0010367 A1
(43) Pub. Date: Jan. 11, 2018

(54) DOOR LOCKING DEVICE

(71) Applicant: SAMSUNG SDS CO., LTD., Seoul (KR)

(72) Inventors: Chul-Ho MAENG, Seoul (KR); Sang-Han LEE, Seoul (KR)

(73) Assignee: SAMSUNG SDS CO., LTD., Seoul (KR)

(21) Appl. No.: 15/644,256

(22) Filed: Jul. 7, 2017

(30) Foreign Application Priority Data
Jul. 7, 2016 (KR) 10-2016-0086126

(51) Int. Cl. E05B 47/00; E05B 15/04; E05B 63/14

(52) U.S. Cl. CPC E05B 47/0012; E05B 15/04; E05B 2047/0026; E05B 2015/0403; E05B 63/14; E05B 2047/0086; E05B 2047/0024

(57) ABSTRACT

A door locking device including a rotary part including a first rotary part and a second rotary part allowed to be changed into a locked state or an unlocked state through rotation; an elastic rotary part rotated by movement of a locking body moved by a key; a cam lever moved by rotation of the elastic rotary part; a clutch pushed and moved by movement of the cam lever; and an interlocking member inserted into the rotary part by movement of the clutch to interlock the first rotary part and the second rotary part is provided.

### CROSS-REFERENCE TO RELATED APPLICATION

This application claims priority to and the benefit of Korean Patent Application No. 10-2016-0086126, filed on Jul. 7, 2016, the disclosure of which is incorporated herein by reference in its entirety.

### BACKGROUND

### 1. Field of the Invention

The present invention relates to a door locking device.

### 2. Discussion of Related Art

Generally, a door locking device is installed at a door of a place such as a house, an apartment or an office to prevent an unauthorized person from entering an inside thereof. A locking mechanism is installed at the door locking device to prevent the door from being opened undesirably from an outside, and a mechanical door lock which is manually locked and unlocked using a key is a most common type. However, the mechanical door lock has a problem of vulnerable security due to a simple structure thereof. To solve the problem, recently, a solenoid operated door lock in which a dead bolt is driven through a user authentication process such as a password, a fingerprint recognition or a card recognition using an electromagnet and a clutch and a motorized door lock in which a motor is driven and a dead bolt is also driven by the motor are mainly used. Among them, the motorized door lock having a simple structure and relatively low power consumption is more preferred. In a conventional mortise, when user authentication is completed, a driving motor is driven to push a guide plate through a clutch pin, such that a connection pin is inserted into a first rotary part and a second rotary part to interlock a dead bolt, a latch bolt and so on and thus a door lock may be unlocked. That is, the second rotary part is connected to a dead bolt driving part, and only the first rotary part is in a rotated state while the connection pin is not inserted into a through-hole of a rotary part, but when the user authentication is performed, the connection pin is inserted into the through-hole of the rotary part, and thus a door may be opened by rotating a doorknob. However, in a clutch structure of the conventional mortise, the connection pin may be difficult to be withdrawn from the through hole of the rotary part due to battery consumption or a usage load while the first rotary part and the second rotary part are warped at a predetermined angle. Accordingly, the connection pin is maintained in a state which may not be withdrawn from the through hole of the rotary part. However, a controller of the door lock does not recognize such a state and determines that the clutch is in a disconnected state, thereby causing a malfunction of the door lock.

### SUMMARY OF THE INVENTION

The present invention is directed to a door locking device capable of manually changing a locked state into an unlocked state using a key when the locked state is not changed into the unlocked state due to discharge of a battery for supplying electric power to a motor while the door locking device is locked and unlocked by the motor.

Also, the present invention is directed to a door locking device capable of providing a structure in which, when a clutch is separated from a spring as an elastic member connected to a motor of the door locking device, the spring and the clutch are coupled again by rotation of the motor.

According to an aspect of the present invention, there is provided a door locking device including a rotary part including a first rotary part and a second rotary part allowed to be changed into a locked state or an unlocked state through rotation; an elastic rotary part rotated by movement of a locking body moved by a key; a cam lever moved by rotation of the elastic rotary part; a clutch pushed and moved by movement of the cam lever; and an interlocking member inserted into the rotary part by movement of the clutch to interlock the first rotary part and the second rotary part.

The door locking device may further include a returning elastic body configured to return the cam lever moved by the elastic rotary part to a position before being moved.

According to another aspect of the present invention, there is provided a door locking device including a rotary part including a first rotary part and a second rotary part allowed to be changed into a locked state or an unlocked state through rotation; an interlocking member inserted into the rotary part to interlock the first rotary part and the second rotary part; a clutch configured to push and insert the interlocking member; and an elastic member configured to move at least a part of the clutch.

The door locking device may further include an elastic rotary part rotated by a locking body which is moved together with a dead bolt according to the locked state or the unlocked state; and a cam lever moved by rotation of the elastic rotary part.

The door locking device may further include a returning elastic body configured to return the cam lever moved by the elastic rotary part to a position before being moved.

The elastic member may have a spiral shape, and at least a part of the elastic member including both ends may include a section in which a spiral diameter is gradually reduced toward both of the ends.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a perspective view illustrating an inside of a door locking device according to one embodiment of the present invention;

FIG. 2 is a perspective view illustrating the inside of the door locking device according to one embodiment of the present invention;

FIG. 3A is a cross-sectional view illustrating a shape of an elastic member included in a motor part according to one embodiment of the present invention, and FIG. 3B is a perspective view illustrating a connection structure of a clutch connected to the elastic member according to one embodiment of the present invention;

FIG. 4A is a view illustrating a state in which the clutch according to one embodiment of the present invention is spaced apart from an interlocking member, and FIG. 4B is a view illustrating a state in which the clutch according to one embodiment of the present invention inserts the interlocking member; and

FIG. 5 is a perspective view illustrating an operation structure according to one embodiment of the present invention.

### DETAILED DESCRIPTION OF EXEMPLARY EMBODIMENTS

Hereinafter, a specific embodiment of the present invention will be described with reference to the accompanying drawings. However, the embodiment is merely an example, and the present invention is not limited thereto.

In the following description, detailed descriptions of well-known functions or constructions will be omitted if they may obscure the invention in unnecessary detail. Also, the terms used herein are defined according to the functions of the present invention. Thus, the terms may vary depending on a user's or operator's intentions or practices. Therefore, the terms used herein must be understood based on the descriptions made herein.

The technical spirit of the present invention is determined by the claims, and the following embodiments are provided to merely explain the technical spirit of the present invention to those skilled in the art to which the present invention pertains.

Hereinafter, one element of a door locking device which is generally referred to as a dead bolt will be described as a first locking part 11 and will be also described separately from a second locking part 12 having the same purpose which allows the door to be maintained in a locked state.

Further, a door locking device 1 of the present invention may be manually and semi-automatically operated. Here, in the semi-automatic operation, the door locking device 1 is operated by rotation of a motor part 100 included therein. Hereinafter, such an operation state is referred to as a normal operation state. And the manual operation is referred to as an emergency state in which the same operation as the above-described operation is performed using a key when the normal operation is impossible due to inability of an operation of the motor part 100.

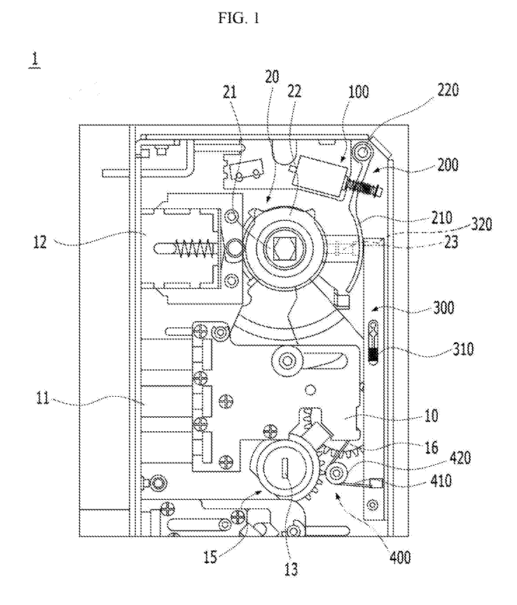

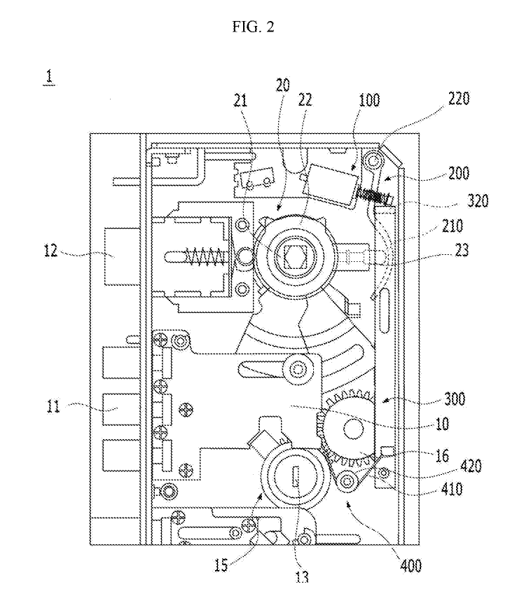

FIGS. 1 and 2 are perspective views of an inside of the door locking device 1 illustrating a cam lever 300 located at different positions according to movement of the cam lever 300 according to one embodiment of the present invention.

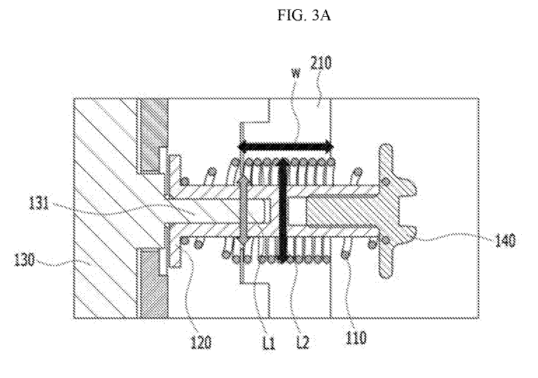

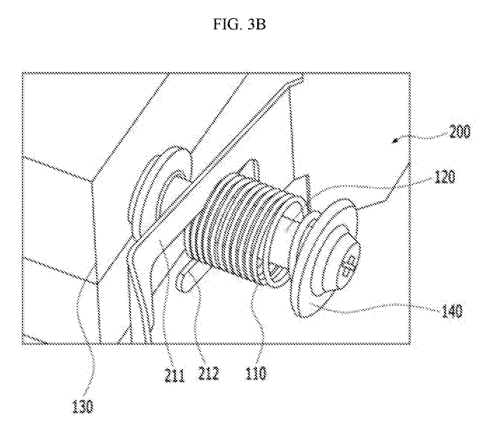

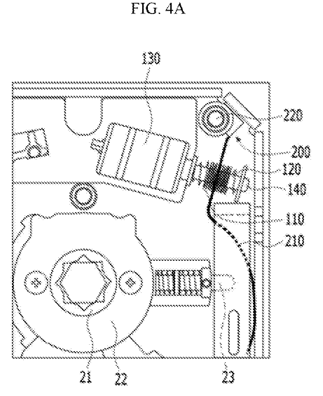

Referring to FIGS. 1 and 2, the door locking device 1 may include the motor part 100, a lever part 200, the cam lever 300 and an elastic rotary part 400. Here, the motor part 100 includes a motor 130 which may be operated by a power supply means, e.g., a battery such as a dry cell, included in the door locking device 1. Such an operation means that normal rotation and reverse rotation can be selectively performed. For example, when the door locking device 1 is installed at a door, assuming that the normal rotation is performed by an operation from an outside of the door, the reverse rotation may be performed by an operation from an inside of the door. Of course, the rotation direction may be set reversely, or one of the normal rotation and the reverse rotation may be in a stopped state, and the rotation direction may also be changed according to a coupling structure between other elements included in the motor 130 and the motor part 100. And the motor part 100 may further include a connection shaft 120 (in FIG. 3) which is connected to a shaft of the motor 130, an elastic member 110 (in FIG. 3) which is located on an outer circumferential surface of the connection shaft 120 (in FIG. 3) and a fixing part 140 (in FIG. 3) which is pressed on and fixed to the elastic member 110 (in FIG. 3) to provide elasticity.

The motor part 100 may be connected to a clutch 210 of the lever part 200, and thus a part of the clutch 210 may move about a clutch shaft 220 by the normal rotation or the reverse rotation of the motor part 100. An interlocking member 23 may move to be inserted into a rotary part 20 by the movement of the clutch 210, and the first locking part 11 and the second locking part 12 may be in a locked state or an unlocked state by rotation of the rotary part 20 in which the interlocking member 23 is inserted.

Here, the interlocking member 23 is formed to have a pin shape and may be a member which is inserted to interlock a first rotary part 21 with a second rotary part 22 and also all type of members which interlock the first rotary part 21 with the second rotary part 22. However, hereinafter, a pin-shaped interlocking member 23 may be described as one example.

Also, the rotary part 20 may include the first rotary part 21 which is connected to an inside of the door to be operated from the inside and the second rotary part 22 which is connected to an outside of the door to be operated from the outside, and the interlocking member 23 may be rotated while interlocking the first rotary part 21 with the second rotary part 22. Therefore, the locked state and the unlocked state of the first locking part 11 may be decided according to the movement of the clutch 210 about the clutch shaft 220.

In a normal state, since the clutch 210 moves depending on rotation of the motor 130, an operating order may include the following processes. The door locking device 1 is installed at the door, the motor part 100 is operated from the outside of the door, i.e., an outdoor side by a means such as a password or a magnetic card, the clutch 210 partially moves by an operation of the motor part 100, and thus the interlocking member 23 may be inserted into the rotary part 20. The first rotary part 21 and the second rotary part 22 may be interlocked by the interlocking member 23 inserted into the rotary part 20 and may be rotated at the same rotation speed and direction. While the rotary part 20 is interlocked, the rotary part 20 may be rotated by a handle such as a lever or a push-pull. The first locking part 11 and the second locking part 12 may be changed into the unlocked state by the rotation.

However, when the power supply means, e.g., the battery such as the dry cell which supplies electric power to the motor part 100 is discharged, the motor 130 may not be rotated. Therefore, the clutch 210 of the lever part 200 may not be moved by the motor part 100. As described above, in the locked state and the unlocked state of the first locking part 11 and the second locking part 12 which are decided according to the movement of the clutch 210, a state change due to the rotation of the motor 130 may be impossible. Therefore, a means for changing the locked state of the first locking part 11 and the second locking part 12 to the unlocked state even in the case of the discharge of the power supply means corresponding to the battery may be further included.

The means may be operated in an emergency while including the following process. When a key is inserted into a key inserting body 15 and then rotated at a predetermined angle, the locked state or the unlocked state of the first locking part 11 may be changed. Here, the key is a member which may rotate the key inserting body 15 when satisfying a predetermined condition that the member may be inserted and rotated. Hereinafter, the member will be referred to as the key. The key inserting body 15 rotated by the key may move a locking body 10 while being rotated by the predetermined angle. Therefore, while the key inserting body 15 is rotated by the key, the locked state or the unlocked state of the first locking part 11 may be decided. A decision factor of the state may be decided by an additional means which may decide the locked state formed at the inside of the door based on the door locking device 1.

Then, when the first locking part 11 moves to be inserted into an inside of the door locking device 1, the locking body 10 may rotate an elastic body 410 by the movement. Two or more elastic bodies 410 may be formed to extend from a shaft portion 420 included in the elastic rotary part 400 at a predetermined angle in a diameter direction. In the case in which two elastic bodies 410 are formed, an end of one of the two elastic bodies 410 may be connected to the locking body 10 and may move according to the movement of the locking body 10, and the other one may be connected to the cam lever 300. For example, each of the elastic bodies 410 may be a spring formed of a metallic material which is wound on the shaft portion 420. And according to the movement of the locking body 10, the elastic bodies 410 may apply a force due to elasticity to the cam lever 300 while the predetermined angle becomes narrower.

Here, the applied force may move the cam lever 300. The cam lever 300 may be connected to the elastic body 410 and may extend to a position at which the clutch 210 is located. A part of the cam lever 300 close to the clutch 210 may insert the interlocking member 23 into the rotary part 20 by the movement. The rotary part 20 in which the interlocking member 23 is inserted may be rotated by the handle such as a lever or a push-pull. The first locking part 11 and the second locking part 12 may be changed to the unlocked state by the rotation.

Therefore, the movement of the clutch 210 may be selectively performed during the operation of the motor part 100 or the movement of the cam lever 300. Here, the motor part 100 may not be operated when the electric power supply from the means for supplying the electric power to the motor part 100 is cut off. However, since the cam lever 300 is mechanically connected to the operation through the key and the operation of the motor part 100, the cam lever 300 may move. That is, the movement of the cam lever 300 may be decided by the elastic body 410, and the movement of the elastic body 410 may be decided by the movement of the locking body 10. Therefore, the operation of the motor part 100 and the rotation of the key inserting body 15 by the key which move the locking body 10 may be included in a factor for the movement of the cam lever 300.

According to the above description, a mechanism in which the first and second locking parts 11 and 12 of the door locking device 1 are changed into the locked state or the unlocked state may include a mechanism according to the manual operation through the key and the semi-automatic operation by the motor 130.

FIG. 3A is a cross-sectional view illustrating a shape of the elastic member 110 included in the motor part 100 according to one embodiment of the present invention, and FIG. 3B is a perspective view illustrating a connection structure of the clutch 210 connected to the elastic member 110 according to one embodiment of the present invention.

Referring to FIGS. 3A and 3B, the motor part 100 may include the motor 130, the connection shaft 120, the elastic member 110 and the fixing part 140. Specifically, one end of the connection shaft 120 may be connected to a motor shaft 131 which transmits a rotating force of the motor 130, and an opposite side to the side connected to the motor shaft 131 may be connected to the fixing part 140. In FIG. 2A, the connection is performed by an inserting or a coupling through a screw thread. However, in a connecting method, a structure and a method thereof are not limited, and various modifications may be provided, as long as a fixed structure which transmits the rotating force may be provided. Here, the elastic member 110 may be formed on an outer circumferential surface of the connection shaft 120 in the form of a spring, and the spring may be formed to have, for example, a spiral shape. And both ends of the elastic member 110 may be fixed to a motor 130 side and a fixing part 140 side, respectively and may be rotated together with rotation of the motor shaft 131.

Meanwhile, the lever part 200 may include engaging portions 211 and 212 to be coupled to the elastic member 110. A distance between the engaging portions 211 and 212 may be formed larger than a diameter of the connection shaft 120, and the connection shaft 120 may be located in a space between the engaging portions 211 and 212. And the engaging portions 211 and 212 may be located between steel wires forming the elastic member 110 having the spring shape. Here, when the motor 130 is rotated, the clutch 210 may be guided by the spiral elastic member 110 in a spiral direction. Therefore, the clutch 210 may move according to a rotating direction of the motor 130 and the spiral elastic member 110.

Further, the elastic member 110 may include a clutch moving section W in an axial direction of the motor 130 which is formed to have a diameter larger than a distance L1 between the engaging portions 211 and 212, thereby forming a section which allows the clutch 210 to be guided. Also, the spiral diameter may be formed to extend to both ends of the elastic member 110 while being reduced from both ends of the clutch moving section W. In this structure, for example, even when a rotating speed of the motor 130 exceeds a predetermined speed and the clutch 210 is deviated from the clutch moving section W, the clutch 210 may be located between the steel wires and may be guided again to the clutch moving section W by the spiral elastic member 110 when the rotating direction is changed. Therefore, the distance L1 between the engaging portions 211 and 212 may be formed smaller than a width L2 of at least a part of the elastic member 110.

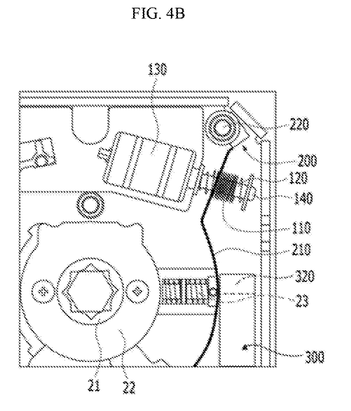

FIG. 4A is a view illustrating a state in which the clutch 210 according to one embodiment of the present invention is spaced apart from the interlocking member 23, and FIG. 4B is a view illustrating a state in which the clutch 210 according to one embodiment of the present invention inserts the interlocking member 23.

Referring to FIGS. 4A and 4B, the operation by the motor part 100 in the mechanism for deciding the locked state and the unlocked state of the first locking part 11 which is described with reference to FIGS. 1 and 2 will be described. As described with reference to FIG. 3, the rotating force may be transmitted to the elastic member 110 by the rotation of the motor 130, and the spiral elastic member 110 may receive the rotating force, may be connected to the engaging portions 211 and 212 of the clutch 210 in a space between the steel wires forming a spiral and may guide the clutch 210. The lever part 200 may be rotated using the clutch shaft 220 as a center axis, and an angle is formed by the guiding length. The angle may form a rotatable angle. Due to the rotatable angle, the clutch 210 may press the interlocking member 23, and the pressed interlocking member 23 may be inserted into the rotary part 20.

The pressed interlocking member 23 may interlock the first rotary part 21 and the second rotary part 22 of the rotary part 20 and may allow the first rotary part 21 and the second rotary part 22 to be rotated together. The fact that the first rotary part 21 and the second rotary part 22 which are independently rotated are interlocked and rotated together in the same direction means that the locked state or the unlocked state of the first locking part 11 and the second locking part 12 may be changed.

Specifically, the door locking device 1 is installed at the door, the motor part 100 is operated from the outside of the door, i.e., the outdoor side by a means such as a password or a magnetic card, the clutch 210 partially moves by the operation of the motor part 100, and thus the interlocking member 23 may be inserted into the rotary part 20. By the interlocking member 23 inserted into the rotary part 20, the first rotary part 21 and the second rotary part 22 may be interlocked and may be rotated at the same speed in the same direction. While the rotary part 20 is interlocked, the rotary part 20 may be rotated by the handle such as a lever or a push-pull. The first locking part 11 and the second locking part 12 may be changed into the unlocked state by the rotation.

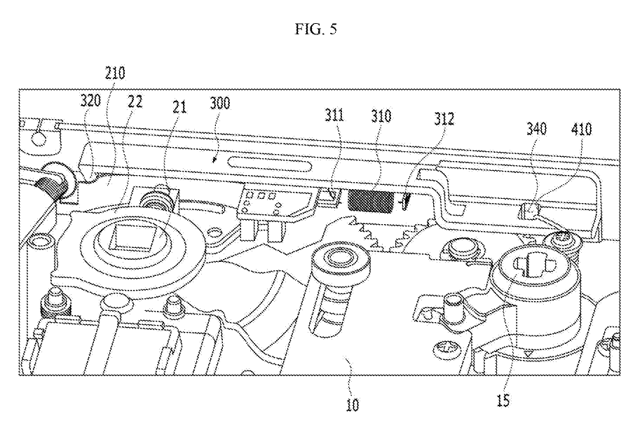

FIG. 5 is a perspective view illustrating an operation structure according to one embodiment of the present invention.

Referring to FIG. 5, the cam lever 300 may be supported and slid by an internal structure of the door locking device 1 and may reciprocate in a section by receiving a force from an outside. Specifically, one end of the cam lever 300 is in contact or spaced by the movement of the clutch 210. When the one end of the cam lever 300 is in contact, the clutch 210 may be pushed toward the interlocking member 23. The elastic body 410 may be connected to the other end of the cam lever 300. As illustrated in FIG. 5, the elastic body 410 may be formed in a ring shape, and an elastic body hooking hole 340 which may be connected to the ring-shaped elastic body 410 may be formed and may be connected to the elastic body 410.

As described above, in FIG. 1, the elastic body 410 may be rotated by the movement of the locking body 10 and then may apply a force to the cam lever 300. At this time, a direction of the applied force may be a direction from the one end of the cam lever 300 toward the other end thereof, and the one end of the cam lever 300 may come in contact with the clutch 210 and may push the clutch 210. Here, a ring-shaped clutch pressing portion 320 may be formed at the cam lever 300 to push the clutch 210. The cam lever 300 may press the clutch 210 while being moved by the clutch pressing portion 320. Also, the clutch 210 may be formed in an arch shape. The arch-shaped clutch 210 may be formed so that a convex portion thereof is directed toward the clutch pressing portion 320, and the clutch pressing portion 320 may push an arch-shaped convex surface due to the movement of the cam lever 300, and thus the clutch 210 may move toward a concave portion thereof. Therefore, the arch-shaped clutch 210 may press the interlocking member 23 with a concave surface thereof. Of course, the clutch 210 may be formed to have a structure other than the arch shape, such that the clutch 210 is pressed by the movement of the cam lever 300 to insert the interlocking member 230 into the rotary part 20.

And the cam lever 300 which has pushed the clutch 210 may be returned to an original position corresponding to a state before pushing the clutch 210. The returning to the original position may be performed by a force transmitted from elasticity of a returning elastic body 310. Specifically, one end of the returning elastic body 310 may be connected to the cam lever 300, and the other end thereof may be connected to a structure fixed to a body or the like of the door locking device 1. When both ends of the returning elastic body 310 are formed to have a ring shape, a structure which may be connected to rings formed at both ends may be formed. A first hooking portion 311 may be formed at a structure which is formed at the door locking device 1 to be fixed and may be connected to the ring formed at one end of the returning elastic body 310, and a second hooking portion 312 formed at the cam lever 300 may be connected to the ring formed at the other end of the returning elastic body 310, thereby moving the cam lever 300 toward the structure. For such movement, the elasticity of the returning elastic body 310 may be formed to be smaller than that acting when the elastic body 410 is contracted. Furthermore, the structure may further include a guide member which guides the cam lever 300 that reciprocates in a section by the returning elastic body 310 and the elastic body 410.

One embodiment of the present invention can provide the door locking device which can manually change the locked state into the unlocked state using a key when the locked state is not changed into the unlocked state due to the discharge of the battery for supplying the electric power to the motor while the door locking device is locked and unlocked by the motor.

Also, one embodiment of the present invention can provide a structure in which, when the clutch is separated from the spring as the elastic member connected to the motor of the door locking device, the spring and the clutch are coupled again by the rotation of the motor.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A door locking device comprising:
a rotary assembly comprising a first rotary part and a second rotary part, the rotary assembly being configured to be changed into a locked state or an unlocked state;
an elastic rotary part configured to be rotated by a movement of a locking body moved by a key;
a cam lever configured to be moved by a rotation of the elastic rotary part;
a clutch configured to be pushed and moved by a movement of the cam lever; and
an interlocking member configured to be inserted into the rotary assembly by a movement of the clutch to interlock the first rotary part and the second rotary part.

2. The door locking device of claim 1, further comprising a returning elastic body configured to return the cam lever moved by the elastic rotary part to a position held before the cam lever was moved by the elastic rotary part.

3. A door locking device comprising:
a rotary assembly comprising a first rotary part and a second rotary part, the rotary assembly being configured to be changed into a locked state or an unlocked state through a rotation;
an interlocking member configured to be inserted into the rotary assembly to interlock the first rotary part and the second rotary part;
a clutch configured to push and insert the interlocking member into the rotary assembly; and
an elastic member configured to move at least a part of the clutch.

4. The door locking device of claim 3, further comprising:
an elastic rotary part configured to be rotated by a locking body which is configured to be moved together with a dead bolt according to the locked state or the unlocked state; and
a cam lever configured to be moved by a rotation of the elastic rotary part.

5. The door locking device of claim 4, further comprising a returning elastic body configured to return the cam lever moved by the elastic rotary part to a position held by the cam lever before the cam lever was moved by the elastic rotary part.

6. The door locking device of any one of claims 3 to 5, wherein the elastic member comprises a spiral shape, and at least a part of the elastic member comprises a section in which a spiral diameter is gradually reduced toward an end of the elastic member.
